(19) United States
(12) Patent Application Publication
(10) Pub. No.: US 2010/0030586 A1
(43) Pub. Date: Feb. 4, 2010

(54) SYSTEMS & METHODS OF CALCULATING AND PRESENTING AUTOMOBILE DRIVING RISKS

(75) Inventors: WARREN TAYLOR, Alpharetta, GA (US); Ash Hassib, Alpharetta, GA (US); Bill Madison, Alpharetta, GA (US)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: CHOICEPOINT SERVICES, INC

(21) Appl. No.: 12/534,055

(22) Filed: Jul. 31, 2009

Related U.S. Application Data
(60) Provisional application No. 61/085,340, filed on Jul. 31, 2008.

(51) Int. Cl. G06Q 40/00

(52) U.S. Cl. 705/4

(57) ABSTRACT

Systems and methods of calculating and presenting automobile driving risks are provided. In accordance with some embodiments, a method of obtaining driving performance data to provide one or more driving performance risk scores derived from received data is provided. The method can generally comprise receiving an initial data set into a memory, the initial data set comprising telematic data that includes driving performance data; transforming at least a part of the initial data set into a production data set such that the transformation augments certain data elements in the initial data set into predetermined states; storing the production data set into a centralized data repository; and receiving one or more data inquiries from one or more interested parties and in response to the one or more data inquiries providing a driving performance risk score based on data stored in the centralized data repository, wherein the driving performance risk score indicates a level of insurance risk. Other aspects, embodiments, and features are claimed and described.

### CROSS REFERENCE TO RELATED APPLICATION & PRIORITY CLAIM

This application claims priority to and the benefit of U.S. Provisional Patent Application No. 61/085,340, filed 31 Jul. 2009, which is incorporated herein by reference in its entirety as if fully set forth below.

### TECHNICAL FIELD

Embodiments of the present invention relate generally to data and communication systems, and more particularly, to telematic systems and methods configures to calculate and provide driving risk date associated with automobile driving.

### BACKGROUND

Conventional methods for obtaining and determining driving performance data related to auto insurance transactions typically involve gathering relevant historical data from personal interviews or written applications. Using these application methods, applicants can choose to provide limited information. In some instances, provided information can be confirmed by checking an applicant's public motor vehicle driving record maintained by a governmental agency, such as a Bureau of Motor Vehicles.

Using application data, insurance companies can classify insurance applicants to a broad actuarial class. Insurance rates can then be assigned based upon the empirical experience of the insurer. Numerous factors are deemed relevant to such classification in addition to a motor vehicle driving record in a particular actuarial class or risk level, such as age, sex, marital status, and location of residence. Conventional insurance systems create groupings of vehicles and drivers (actuarial classes) utilizing driving records as one of the major contributing factors in assigning actuarial classes or risk levels. Other factors include:
Vehicle Age
Vehicle Manufacturer
Vehicle Model
Vehicle Value.
Driver Age
Driver Gender
Driver Marital Status
Driver's Driving Record (Based on government Reports)
Driver's Reported Violations (Citations)
Driver's Claims History
Driver's Number of At Fault Accidents
Driver's Place of Residence
Driver's Policy Coverage
Driver's Types of Losses Covered
Driver's Liability Coverage Levels
Driver's Uninsured or underinsured motorist Coverage Levels
Drivers Comprehensive, Collision; Liability Limits; and Deductibles

Classifications, such as the Driver's Reported Violations (Citations), are further broken into violation classification types such as minor or major violations that help calculate a unique vehicle insurance cost based on the specific combination of attributes for a particular risk. A status change in an individual's driving record might result in a different premium being charged, if the change resulted in a changed actuarial class or risk level. For instance, on one hand, a minor violation being identified for a parking violation may not result in a different actuarial class due to empirical experience of the insurance carrier. On the other hand, a major violation may result in a different premium because insurer's records indicate a difference in risk associated with those types of violations, therefore, the violation type difference results in a change in actuarial class or assigned risk level.

A problem with conventional driving performance reporting is that much of the data is gathered from applicants' driving records. This data is largely based on historical actions of drivers where law enforcement and unlawful or unsafe driving performance coincide (e.g., a driver being issued a citation for speeding 15 MPH over the speed limit). This type of data capture, however, is primarily based on past realized losses and other drivers with similar characteristics. None of the data obtained through conventional systems necessarily reliably monitors the manner or safety of current operation of the vehicle or the driver's performance. Insurers, however, have no other choice than to utilize the data they have available in the form of state government driving records to help them assess the driving performance of the driver/applicant. This limited amount of information based on past historical events has generated a long-felt need for improved systems and methods for more reliably accumulating data having a highly relevant evidential value towards determining the risk associated with a particular driver and or vehicle based on the driving performance of the vehicle or driver.

There are also conventional vehicle operating data recording systems that have been suggested for purposes of obtaining an accurate record of certain elements of vehicle operation. Some are suggested for identifying the cause for an accident; others are for more accurately assessing the efficiency of operation and/or environmental emissions of a vehicle. Such systems disclose a variety of conventional techniques for recording vehicle operation data elements in a variety of data recording systems.

The various forms and types of vehicle operating data acquisition and recording systems that have heretofore been suggested and employed have met with varying degrees of success for their respective purposes in direct individual applications. All possess drawbacks in that they have limited economic and practical value for a system intended to provide enhanced acquisition, recording, and/or communication of data which would be both comprehensive and reliable in predicting an accurate and adequate measure of driver performance that could be utilized to determine the cost of insurance for the vehicle.

What is needed, therefore, are improved telematic systems and methods configured to calculate and provide driving risk date associated with automobile driving. It is to the provision of such systems and methods that the various embodiments of the present invention are directed.

### BRIEF SUMMARY OF EXEMPLARY EMBODIMENTS

Embodiments of the present invention address the deficiencies of current motor vehicle insurance systems by calculating a driver risk score and providing a system that utilizes a centralized secure repository of driver performance data. Embodiments of the present invention enable driver performance data and developed risk scores to be shared across all parties contributing data to the data repository, mainly but not limited to the insurance industry. This feature provides the ability for a potential insurance provider to procure current and predictive view of future driving performance associated with a driver in question. In addition, vehicles can be utilized as a component of determining rating class or risk level when a new applicant requests coverage. Embodiments of the present invention also enable insurers to provide consumers with the ability to obtain accurate pricing from an insurance carrier without having to implement a carrier specific vehicle operating data acquisition system. Accurate pricing can advantageously prevent or mitigate situations in which applicants encounter a rate determination that may be at a higher premium rate due to unknown driving performance information.

Since the type of operating information acquired and recorded in prior systems was generally never intended to be used for determining driver and vehicle driving performance for the purposes of determining the cost of vehicle insurance, the data elements that were monitored and recorded therein were not directly related to predetermined safety standards or the determining of an actuarial class or risk level for the vehicle operator. For example, recording data characteristics relevant to the vehicle's exhaust emissions may be completely unrelated to the driving performance of the vehicle. Further, there is the problem of recording and subsequently compiling the relevant data for an accurate determination of an actuarial profile and an appropriate insurance cost there for. Current motor vehicle control and operating systems comprise electronic systems readily adaptable for modification to obtain the desired types of information relevant to determination of vehicle and driver driving performance as it pertains to assessing high-risk or low-risk with regard to vehicle safety associated with determining the cost of insurance.

On-line Web sites for marketing and selling of goods and services have become common place. Many insurers now offer communication services to customers via Web sites relevant to the insured's existing insurance profile and current account status. Customer acceptance and common use of this web site communication has generated the need for systems which can provide even more useful information to customers relative to a customer's contract with the insurer. Such enhanced communications can be particularly useful to an insured when the subject of the communications relates to cost determination, or when the subject relates to prospective reoccurring insurable events wherein the system can relate in the existing insured's profile with some insurer-provided estimates to the effect that a future event or method of operating a unit of risk would have on an estimated cost of insuring the unit of risk.

Certain embodiments of the present invention can be utilized as a component within existing insurance operations in determining an insured unit of risk, such as a machine. This can help alleviate problems associated with accurately determining cost of insurance based upon data that fails to consider how a specific unit of risk or machine is operated or decisions made by a particular unit of risk owner or operator. Embodiments of the invention can be used to determine driving performance as one component to determine base insurance charges. Embodiments can also be used to provide a precise classification rating of how an operator operates a vehicle and/or how the vehicle is operated to help determine an appropriate actuarial class. Determination of an appropriate actuarial class can aid in reducing rating error over conventional means of determining driving performance.

Additionally, embodiments enable frequent adjustment (e.g., daily, monthly, quarterly, semiannually, etc.) to individual driving performance record which can have an impact on the cost of insurance because of the changes in operating behavior patterns. This can result in insurance charges that are readily controllable by individual operators and produce safer driving habits overall. Embodiments can also be used in additional insurance based applications such as but not limited to claims monitoring, accident identification, policy renewal processing, and mid-tem exception reporting and termination processes.

In some embodiments, the invention includes a process for collecting data to be used for the following insurance and non-insurance related purposes: advertising and marketing; site selection; transportation services; land use planning; determining road design, surface or composition; traffic planning and design; and road conditions.

In other embodiments, the invention can be configured as a system that is adaptable to current electronic operating systems, tracking systems, and communicating systems for improved extraction of selected insurance related data across multiple contributing providers to produce a centralized contributory repository. Some system embodiments enable enhanced and improved communication and analysis of relevant acquired data as it relates to driving performance associated with customer insured profiles through multiple channels of commerce including but not limited to personal computers, system to system electronic communications, and/or Internet/Web applications.

In accordance with some embodiments of the present invention, a system to provide driving performance data is provided. The system can generally comprise a centralized database and a driving performance engine. The centralized database can be configured to receive and store telematic driver data and vehicle data from a plurality of unique data sources. The data can be representative of a plurality of drivers and automobiles, including characteristics associated with the drivers and the automobiles. The driving performance engine can be configured to analyze data stored in the centralized database and in response to the analysis to provide a driver performance risk score that indicates a level of insurance risk associated with at least one of a driver or a vehicle. A system can also comprise a data receipt processor operable to manage receipt of telemetric driver and vehicle data in a first data format and transform at least some data elements of the telemetric driver and vehicle data into a second data format. A system can also include a standard violation code engine configured to assign one or more violation codes to events in a driver historical record and evaluate the assigned codes to determine violation patterns and driving risk levels. A system can also include a plurality of data interfaces configured to receive telemetric driver and automobile data from a plurality of unique users in a plurality of unique data formats.

System embodiments of the present invention can also include other features. For example, the driving performance engine can generate a driving performance report in response to an inquiry requesting a driving performance report, wherein the driving performance report includes the driving performance risk score and on or more data elements comprising driving performance dates, monitoring periods, vehicle/driver risk situations, and a vehicle identification number. The driving performance engine can provide a driver performance risk score as a function of driver performance data and driver insurance claims history. The driving performance engine can provide the driver performance risk score as a function of vehicle performance data and vehicle insurance claims history. The driving performance engine can provide the driver performance risk score for a specific driver based on a correlation of a propensity of claims loss factor relative to the specific driver's driving performance data. The driving performance engine provides the driver performance risk score at a predetermined frequency so that the frequently provided driver performance risk score can be used to adjust an insurance rate associated with a driver or a vehicle. Analyzed vehicle data can include vehicle operational characteristics.

Method embodiments are also contemplated in accordance with the present invention. For example, some embodiments can be a method of obtaining driving performance data to provide one or more driving performance risk scores derived from received data. Such a method can include receiving an initial data set into a memory, the initial data set comprising telematic data that includes driving performance data and transforming at least a part of the initial data set into a production data set such that the transformation augments certain data elements in the initial data set into predetermined states. A method embodiment can also include storing the production data set into a centralized data repository and receiving one or more data inquiries from one or more interested parties. In response to the one or more data inquiries, a method can include providing a driving performance risk score based on data stored in the centralized data repository, wherein the driving performance risk score indicates a level of insurance risk. Some method embodiments can also include generating a performance driving report that includes the driving performance risk score and on or more data elements comprising driving performance dates, monitoring periods, vehicle/driver risk situations, and a vehicle identification number.

Method embodiments of the present invention can also include other features. For example, transforming the initial data set into a production data set can comprise formatting and validating the initial data set, and changing elements in the initial data set based on the formatting and validating. Also, deriving performance risk score can be provided for at least one of a unique driver or a unique automobile. Providing the driving performance risk score can comprise correlating driver performance data with historical insurance claim information for a unique driver. And in some embodiments, providing the driving performance risk score can include applying a set of predetermined violation codes to the production data set to enable pattern. Some embodiments can include receiving an initial data set comprises receiving data from one or more of a consumer, a telematics service provider, or an insurer. Receiving an initial data set can comprise receiving data collected by telematic sensors positioned to collect driving data in or more vehicles.

There are also other method features contemplated by the various embodiments of the present invention. For example, receiving an initial data set can comprise receiving data from a plurality of unique insurers in varying data formats. Also, providing the driving performance risk score can occurs at a predetermined frequency so that the driving performance risk score can be used by an end user. End user use can includes using the driving performance risk score as a component in providing an insurance rate associated with a driver or a vehicle. An insurance decision engine can use the driving performance risk score to determine change to an existing insurance policy, to review an insurance policy, or alter a rate of an existing policy.

Other aspects and features of embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures, all embodiments of the present invention can include one or more of the advantageous features discussed herein. In other words, while one or more embodiments may be discussed as having certain advantageous features, one or more of such features may also be used in accordance with the various embodiments of the invention discussed herein. In addition, while discussion contained herein may, at times, focus on insurance applications, embodiments of the present invention can also be used in other settings. In similar fashion, while exemplary embodiments may be discussed below as system or method embodiments it is to be understood that such exemplary embodiments can be implemented in various systems, and methods.

### BRIEF DESCRIPTION OF FIGURES

FIG. 1 illustrates a logical flow diagram of a method to obtain driving performance data that includes a driving performance risk score in accordance with some embodiments of the present invention.

FIG. 2 illustrates a logical flow diagram outlining data contribution methods and data load processes to load data into a centralized repository in accordance with some embodiments of the present invention.

FIG. 3 illustrates a logical flow diagram outlining consumer inquiry and insurance response associated with utilizing a contributory database along with derived performance score in accordance with some embodiments of the present invention.

FIG. 4 illustrates a logical flow/block diagram of an underwriting and rating method for determining a cost of insurance in accordance with some embodiments of the present invention.

FIG. 5 illustrates a logical flow/block diagram of a vehicle onboard computer and recording system capable of being used as part of embodiments of the present invention.

FIG. 6 illustrates a perspective view of a vehicle equipped with various sensors to provide data and capable of being used as part of embodiments of the present invention.

FIG. 7 illustrates a display screen/driving performance report detailing customer response of information capable of being derived from a centralized repository in accordance with some embodiments of the present invention.

FIG. 8 is an example listing of violation codes that can be utilized to standardize violation activity into uniform classifications in accordance with some embodiments of the present invention.

### DETAILED DESCRIPTION OF PREFERRED & ALTERNATIVE EMBODIMENTS

To facilitate an understanding of the principles and features of the various embodiments of the invention, various illustrative embodiments are explained below. Embodiments of the present invention may be described below with reference to insurance applications. The embodiments of the invention, however, are not so limited. Briefly described, in preferred form, an embodiment of present invention includes a central repository housing contributed data. The data can be provided by, or on behalf of, insurance carriers, employers, transportation manufacturers including, but not limited to, private passenger and fleet automobile motorcycle, capital farm and construction equipment, motor home, and trucking manufacturers, government entities and individual consumers for the purposes of determining driving performance of a specific vehicle or driver.

Embodiments of the present invention can utilize advantageous features to provide improved telematic systems and methods configured to calculate and provide driving risk date associated with automobile driving. For example, embodiments of the present invention can utilize contributory data. This can be provided through various contribution channels including, but not limited to, contributions from insurers, consumers, telematics service providers, and other organizations interested in providing data in a centralized contributory data repository. Another feature includes applying standard violation codes to specific behaviors to aid in assessing driving performance data. Yet another feature involves development of a driving performance risk score. A risk score can be developed utilizing data attributes associated with data related to a driver or vehicle in question (both driver performance data from the centralized contributory data repository as well as data from a proprietary claims history database). Risk scores can correlate the propensity for potential loss associated with specific driving performance behaviors.

Embodiments of the present invention comprise systems and methods of collecting, aggregating and analyzing driver and vehicle data though a centralized contributory database. The contributory aspect of the data will be provided though various contribution channels including but not limited to contributions through an insurer, contribution through a telematics based service provider, and direct contribution from consumers and other organizations equipped with the necessary technology to download and transfer the identified data required to be included in the centralized contributory data repository.

Data contributions will be received at regularly scheduled intervals which include but are not limited to hourly, daily, weekly, and monthly contribution periods and come from multiple sources across multiple industries as discussed in more detail below. Organizations wanting to utilize services developed to access data from within the centralized contributory data repository can contribute data to gain access to the developed services. Data can be contributed by numerous identification factors including but not limited to vehicle based identifiers such as vehicle identification number (VIN), developed vehicle ID, and vehicle license plate/tag number as well as identifiers containing relevant information related to the vehicle owner or operator that include but are not limited to a diver's state issues driver's license (DL) number, name (first name, middle name, last name), address (including street address, city, state, and zip code) date of birth (DOB), social security number (SSN), phone number, and policy number that provide easily identifiable linkages and ability to connect disparate data enabling the ability to search the database for relevant results. Data formatting, validation, indexing and load routines can ensure data quality.

Some embodiments of the present invention can utilize standard violation codes to code specific behaviors identified within the driving performance data and involves the development of a driving performance risk score that is developed utilizing data attributes associated with the data related to the driver or vehicle in question (both driver performance data from the centralized contributory data repository as well as data from a proprietary claims history database). This risk score will correlate the propensity for potential loss associated with specific driving performance behaviors.

It is anticipated that embodiments of the invention will be used as a component within existing insurance operations to determine an insured unit of risk, such as a machine. This can overcome the problem of accurately determining cost of insurance based upon data which does not take into consideration how a specific unit of risk or machine is operated or decisions made by a particular unit of risk owner or operator.

Embodiments of the invention can be used by insurance companies to determine driving performance that they will be utilized as one component required to determine base insurance charges with regard to current material data representative of actual decisions made by the operator and/or operating characteristics to provide a more precise classification rating of how the operator operates the vehicle or how the vehicle is operated in determining an actuarial class which may have a vastly reduced rating error over conventional means of determining driving performance. Additionally, embodiments enable frequent adjustment (e.g., daily, monthly, quarterly, semiannually, etc.) to individual driving performance record which can have an impact on the cost of insurance because of the changes in operating behavior patterns. This can result in insurance charges that are readily controllable by individual operators and produce safer driving habits overall.

Consumer opt-in aspects of data contribution may not a requirement of the database as information will be aggregated from multiple disparate contributors. A centralized repository would permit insurance carriers, government agencies, and others to use identified driving performance risk factors to rate or quote an automobile insurance policy as well as evaluate ongoing driving behavior that could help assess existing and future risk, potential loss, and any other use permitted or otherwise not restricted by law which may reasonably be expected to be part of the normal course and scope of business or industry/profession.

Consumers using telematic services can also independently opt-in to provide information for future use in seeking insurance pricing and policy information. Contributions may comprise nothing more than submission of information through the use of available telematic devices and/or services or data extracted from in-car devices and/or services through various telematic or other extract methods (OBD port, etc.).

Although embodiments of the present invention are anticipated to be useful for the insurance industry, embodiments of the present invention have other applications. As an example, employers can use the present invention for maintenance, training, and HR purposes. Vehicle usage can be tracked and based on pre-existing knowledge of a transportation unit (vehicle) as well as information received from the vehicle more knowledgeable and programmatic methodology may be used in designing maintenance schedules and replacements. In addition, drivers associated with an assigned vehicle may be effectively monitored for adherence to performance based guidelines such as obeying traffic laws and speed limits, as well as defined company standards. Other users of embodiments of the present invention can include, but are not be limited to, government agencies (for insurance, human resource/employment, traffic safety/research purposes), youthful, newly licensed, and restricted driver/vehicle monitoring programs, (and other defined and undefined purposes), commercial fleet management of vehicles in service, rental agencies (private passenger automobile and commercial rental (vehicle or equipment) for rental, usage, geo-fencing and asset tracking), and consumer protection applications related to a vehicle's history and operational background (example: Carfax, Autocheck vehicle history services). Embodiments of the present invention can also be implemented as a process for collecting data to be used for the following insurance and non-insurance related purposes: advertising and marketing; site selection; transportation services; land use planning; determining road design, surface or composition; traffic planning and design; and road conditions.

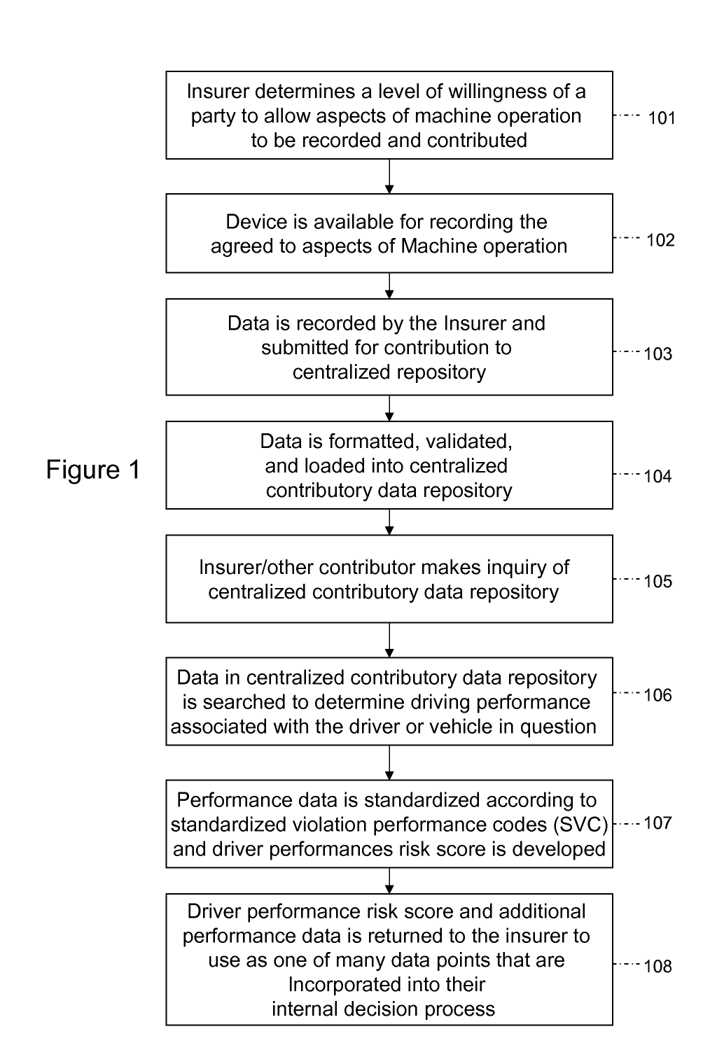

Referring now to the figures, wherein like reference numerals represent like parts throughout the views, exemplary embodiments of the present invention are described in detail. FIG. 1 illustrates a logical flow diagram of a method 100 to obtain driving performance data that includes a deriving performance risk score in accordance with some embodiments of the present invention. Risk scores can be utilized as one of numerous data elements during insurance underwriting and rating processes. Risk scores can include information related to the operation of a vehicle or machine associated with a party requesting insurance coverage.

Logic block 101 illustrates that the method 100 can include determining a level of willingness of a party or potential insured consumer to share telemetric information. In some instances, insurers can implement this action. Sharing telemetric information can include allow aspects of machines operated by users to provide information. It is possible that this could be covered under an insurers policy whereby an insured agrees to be monitored. Shared data can be used for ongoing monitoring under a policy and also can be contributed to a centralized repository.

In accordance with embodiments of the present invention, at least one aspect of machine operation to be recorded can be achieved a number of ways. For example, if an unsolicited request for a recording device is received, it may indicate a relatively high level of willingness or enthusiasm for allowing at least the one aspect of machine operation to be monitored or recorded. Over time, it may be determined that machine operators or owners who are not an insurer's customers, yet who request devices for recording, are more enthusiastic or have a higher level of willingness to have the at least one aspect of their machine operation monitored as opposed to the insurer's customers who request the device. Receiving a device request after making an offer to provide the device may indicate a level of willingness or may indicate a somewhat diminished level of willingness as someone responding to an offer has an easier route to receiving the device than someone who has not received an offer and requests the device at his own initiative.

It is assumed that a level of willingness to have an aspect of machine operation monitored may be related to a manner in which the machine is normally operated. For instance, it is assumed that automobile drivers who believe themselves to be careful automobile drivers would be or are more willing to have an aspect of their driving, such as, for example, the speed at which they drive, monitored and that those who are aware that others would consider them reckless would be less willing to have an aspect of their driving monitored. These assumptions, however, may be inaccurate. Over time, a data aggregator can utilize monitored information to update and include in an existing contributory policy database that includes information correlating the degree of willingness (or unwillingness) to allow recording or monitoring, as well as data regarding the at least one aspect of operation, with a level of risk for various parties.

Of course, parties that actually use a monitoring device for recording the at least one aspect of machine operation indicate a greater willingness to allow one or more aspects of machine operation to be recorded than do those who merely request the device, but do not thereafter actually use the device. Again, it is assumed that those parties that install the device and allow it to record one or more machine operation aspects are more likely to be careful machine operators than are those who do not. Further, those who review the recorded information to determine, for example, if they are indeed as careful as they believe they are, express a greater willingness to allow the monitoring and are likely to be among the most careful drivers. Those who actually provide the recorded information to the insurer express an even greater willingness to be monitored and are likely to be the most careful machine operators of all.

Logic block 102 illustrates that the method 100 can include making telematic available for recording driving and vehicle data in accordance with some embodiments of the present invention. Telematic recording devices can be provided and read by services providers. In some embodiments, providing a data record device to obtain information regarding operational aspects of a machine can include providing a means for transferring the recorded information, or a copy thereof, from the device configured to receive and record information within the vehicle to a device configured to display at least a portion of the recorded information. As an example, many telematic based service providers provide a means for transferring the recorded information, or a copy thereof, can include providing a cable for connecting the device to a communications port USB port or a parallel port) of a home computer, programmable digital assistant or other computation platform. Alternatively, the means for transferring a copy of the recorded information from the device to the display device or telematics service provider can include providing a wireless connection. For example, the device may include means for wireless communication, such as for example, Bluetooth® or other wireless networking or communications technology.

Logic block 103 illustrates that the method 100 can include submitting recorded telematic data can to a centralized repository (or database). Data stored in a centralized repository can be used or queried by contributing members, in accordance with some embodiments. For example, data can be collected from telematics based service providers by insurers with pay as you drive insurance applications and this information can be contributed to the centralized contributory data repository. An insurer may collect this type of performance based information for use within their pay as you drive insurance applications and on a regular basis submit data contributions in multiple electronic formats to the centralized contributory data repository. An example of contribution format may be secure file transfer protocol (SFTP).

Telematic data can be submitted to a centralized repository by other means. For example, telematics based service providers can directly submit data to the centralized contributory data repository. Also consumers and/or other business entities can directly contribute data to the centralized contributory data repository. By enabling various manners of data submission, the inventors aim to build a database having a wealth of data that can be used to provide driver performance and vehicle performance data. This date can be used to derive risk scores to help insurers associate a level of risk to drivers and/or vehicles.

Logic block 104 illustrates that the method 100 can include transformation of submitted data from an initial form to a production form. Transformation can be carried out by a transformation processor. Transformation can include data formatting and data validation. This will help ensure that submitted data of many different forms is put into a common format and that the integrity of the data is not compromised. Load programs can be utilized prior to moving the contributed data to a production form. In production form, data can be searched or queried by users (e.g., contributing parties).

In accordance with some embodiments, contributed data can be formatted, validated, and loaded. Formatting date provides the ability to provide consistent search methods and inquiry search routines as well as develop automated load programs that help improve data quality and accuracy of information returned. Contributed data will also be subject to validation routines prior to load into a production environment to ensure the quality of the data. An example of this is to validate that a contributed vehicle VIN number is within the standardized format for a VIN prior to data load and not in another record layout placement. Formatted and validated data can be loaded into a centralized contributory data repository for later use.

Logic block 105 illustrates that the method 100 can include receiving a search query from one or more users. In some embodiments, users can be an insurer or other contributor inquiring or searching the centralized contributory data repository for driving performance information related to a specific driver or vehicle.

Logic block 106 illustrates that the method 100 can include searching data stored within a centralized data repository. Data housed within the centralized data repository can be searched utilizing developed search routines and algorithms to develop information that will be formatted for response. Inquiries can be made using individual or multiple identification factors, including but not limited to, vehicle based identifiers (e.g., vehicle identification numbers (VIN)), vehicle IDs, and vehicle license plate/tag number as well as identifiers containing relevant information related to the vehicle owner or operator that include but are not limited to a diver's state issues driver's license (DL) number, name (first name, middle name, last name), address (including street address, city, state, and zip code) date of birth (DOB), social security number (SSN), phone number, and policy number.

Logic block 107 illustrates that the method 100 can include standardizing data when providing query response. Embodiments of the present invention can return a risk score that is developed utilizing driver performance data housed in the centralized contributory data repository in combination with historical claims that reside within an existing proprietary database. Embodiments of the present invention can also standardize specific performance attributes that are linked to proprietary standard violation codes to identify high risk behaviors that may increase overall risk. Data can also be formatted to provide monitoring periods, total amount of time a vehicle or driver is found to be within a high risk situation, percentage of total operating time a vehicle is found to be within a high risk situation along with driver and vehicle identification information that may include but is not limited to a Vehicle Identification Number (VIN), Drivers License Number, or developed Driver Biometric Number.

Logic block 108 illustrates that the method 100 can also include returning data to users. For example, formatted performance data can be provided to an inquiring party (e.g., an insurer or other contributing party) in a standardized format. The format can include driver performance risk score, performance dates, monitoring periods, total amount of time a vehicle or driver is found to be within a high risk situation, percentage of total operating time a vehicle is found to be within a high risk situation along with driver and vehicle identification information that may include but is not limited to a Vehicle Identification Number (VIN), Drivers License Number, or developed Driver Biometric Number. This information can be utilized with an inquirer's internal processes as a data component (that will be utilized with many other internal and external data components) in a decision determination whether it be to set a price for insurance or to other identified business use.

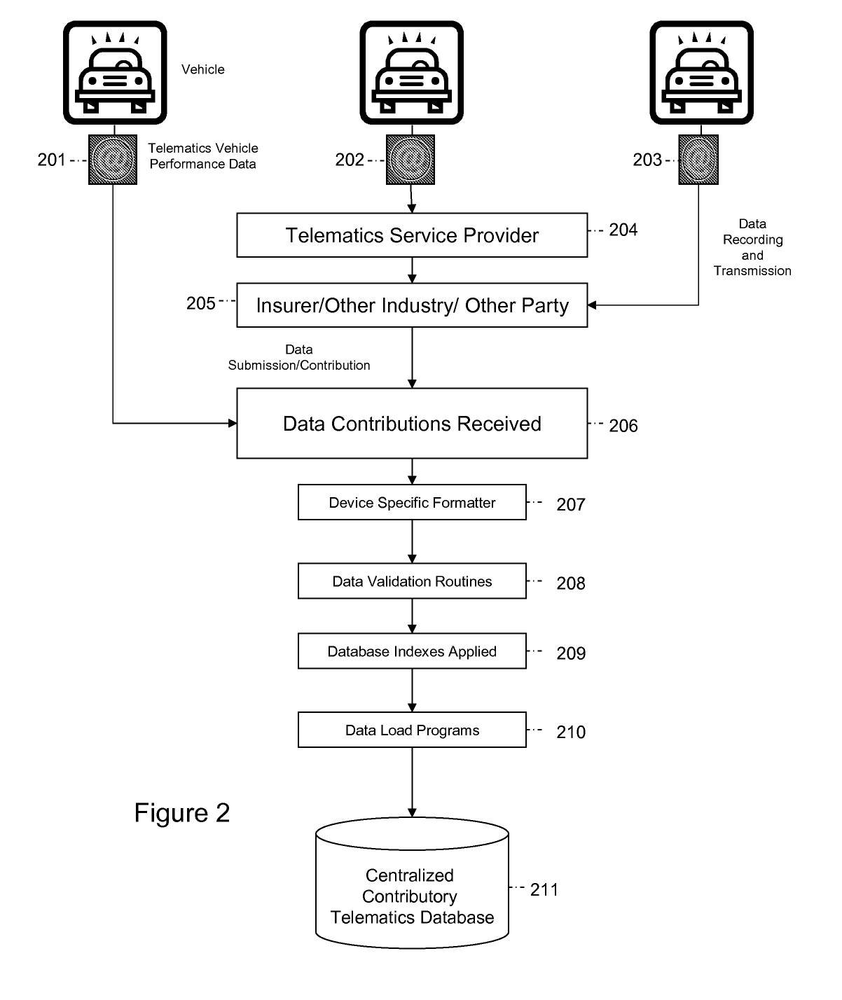

FIG. 2 illustrates a logical flow diagram 200 outlining data contribution methods and data load processes to load data into a centralized repository in accordance with some embodiments of the present invention. The flow diagram 200 generally outlines data contribution methods and data load processes in accordance with some embodiments of the present invention. Logic block 201 shows driving performance based telematic data being contributed directly by a consumer or other party equipped with a vehicle telematic based recording and transmission device for inclusion in the centralized contributory data repository.

Logic block 202 shows driving performance based telematic data being contributed directly by a telematics based service providers. Service provides can obtain data by recording driver performance data from vehicles equipped with specific telematic equipment and transmission devices. Service provides can collect the telematics data and contribute it to the centralized contributory data repository.

Logic block 203 shows driving performance based telematic data being contributed directly by an insurance company (or other entity). Data can be obtained through existing operations. In some cases, obtained data can be associated with but not limited to pay-as-you-drive-insurance applications. Data can be obtained by means of recording driver performance data from vehicles equipped with specific telematic equipment and transmission devices collected by the insurer and then submitted for inclusion in the centralized contributory data repository.

Logic blocks 204, 205, and 206 illustrate various parties who collect driver performance data in accordance with embodiments of the present invention. Logic block 204 illustrates that a telematics based service provider can collect driver performance data. Logic block 205 illustrates that an insurer/other industry/other party can collects driver performance data from telematic based applications. And logic block 206 illustrates that telematics based data can be recorded by the insurer or other contributing telematics based service provider and submitted to the centralized repository for use in future inquiries by contributing members.

In some embodiments, data will be collected from telematics based service providers by insurers with pay as you drive insurance applications which will then be contributed to the centralized contributory data repository. For example, an insurer my collect this type of performance based information for use within their pay as you drive insurance applications and on a regular basis submit data contributions in multiple electronic formats or other means (storage tape, etc) that can be uploaded to the centralized contributory data repository. An example of contribution format may be secure file transfer protocol (SFTP) which is a standard protocol for the secure transfer of data over an electronic connection. In other embodiments, telematics based service providers will directly submit data to the centralized contributory data repository. There will also be a manner for consumers and/or other business entities to directly contribute data to the centralized contributory data repository utilizing methods mentioned in previous sections of this document.

Logic block 207 shows that embodiments of the present invention can include transforming data from one state to another state for use. For example, data formatting routines and processes can be used to format contributed data. This can provide the ability to provide consistent search methods and inquiry search routines as well as develop automated load programs that help improve data quality and accuracy of information returned.

Logic block 208 illustrates that embodiments of the present invention can test data for validity. For example, data validation routines and processes can operate on contributed data prior to being loaded into a production environment to ensure the quality of the data. This ensures information is in standardized formats and in the correct place within the record layout.

Logic blocks 209, 210, and 211 also further illustrate how embodiments of the present invention can test and transform contributed data. For example, logic block 209 illustrates database indexes being applied to contributed data to help improve search performance. Logic block 210 illustrates data load processes capable of loading data that has been formatted and validated into a production environment. And logic block 211 illustrates a production ready centralized contributory data repository available for processing queries.

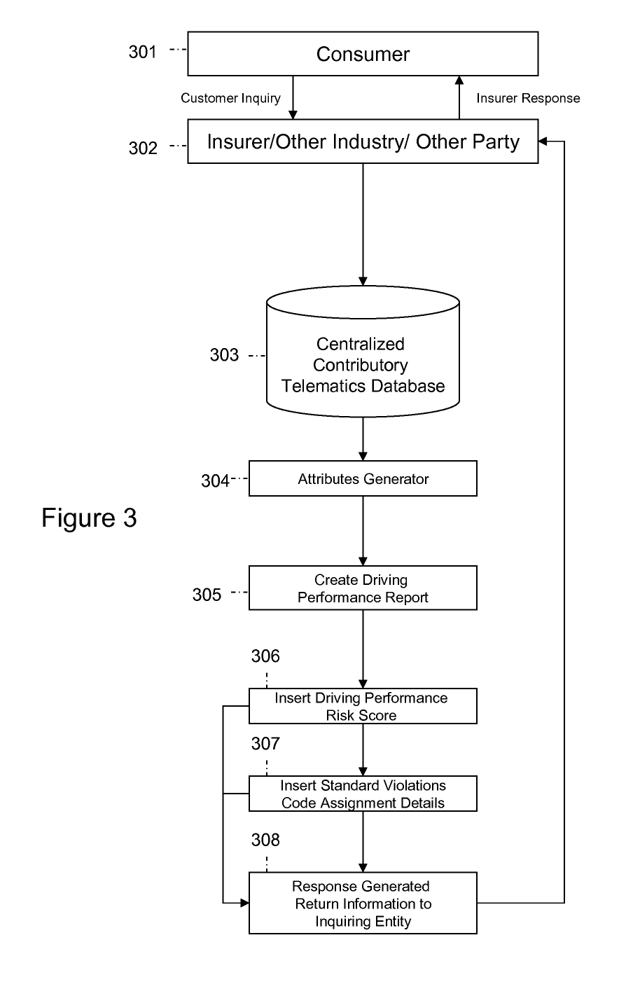

FIG. 3 illustrates a logical flow diagram 300 outlining consumer inquiry and insurance response associated with utilizing a contributory database along with derived performance score in accordance with some embodiments of the present invention. Logic block 301 shows a consumer making an inquiry to obtain insurance or other desired product and/or service. Logic block 302 illustrates an insurer or other interested party who contributes to the centralized contributory data repository making an inquiry on the database. The inquiry can be related to one or more consumers and/or vehicles that an insurance company is interested in knowing driving performance information. Logic block 303 represents a production ready centralized contributory data repository capable of receiving and responding to inquires.

In accordance with embodiments of the present invention, repositories and databases can receive inquires, analyze data, and provide query response. For example, logic block 304 illustrates that a system can include an attribute generator. An attribute generator can be used to develop data attributes associated with the data related to the driver or vehicle in question (both driver performance data from the centralized contributory data repository as well as data from a proprietary claims history database). Developed attributes can be used as a component in developing a driver performance risk score. Exemplary attributes can including determining various patterns of vehicle operation by one or more drivers to derive behavior patterns. These patterns can be provided to an interested party for use and/or can be used as a component of driving performance score.

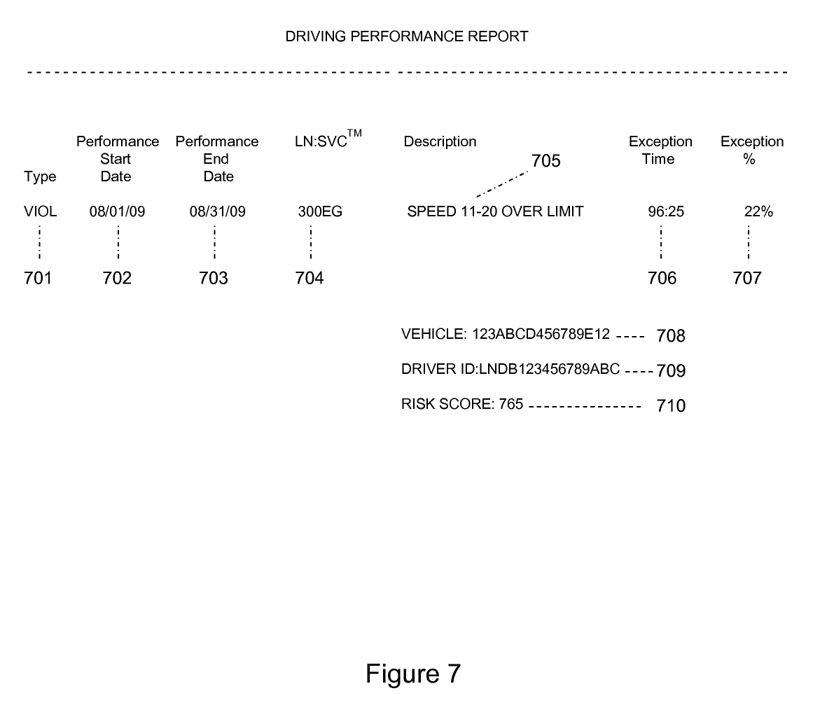

Logic block 305 illustrates that embodiments of the present invention can generate a populate a driving performance report. An exemplary report is discussed below in more detail with reference to FIG. 7. Driving performance reports can reference formatted performance data in a standardized format. The data can include driver performance risk score, performance dates, monitoring periods, total amount of time a vehicle or driver is found to be within a high risk situation, percentage of total operating time a vehicle is found to be within a high risk situation along with driver and vehicle identification information that may include but is not limited to a Vehicle Identification Number (VIN), Drivers License Number, or developed Driver Biometric Number.

Logic block 306 illustrates that embodiments of the present invention can calculate a driver performance risk score. Development of a driver performance risk score can be done utilizing data attributes associated with the data related to a driver or vehicle (both driver performance data from the centralized contributory data repository as well as data from a proprietary claims history database). The calculated driver performance risk score can be inserted into the above mentioned driving performance report. Risk scores can be calculated to correlate the propensity for potential claim loss associated with specific driving performance behaviors. As an example, a driver performance risk score can be like a credit score, the higher the score, the better your risk score will be which translates into the less likely you are to have claims loss currently and in the future. It should be understood that driver performance risk scores can be determined based on a function of vehicle operation data, a driver's driving characteristics, and other data elements discussed herein.

Logic block 307 illustrates that embodiments of the present invention can include applying violation codes to driving performance data. Violation codes can be standardized so that patterns in driving and vehicle performance can be detected. Applied violation codes can also be provided in a driving performance report. For example, if it is determined that a vehicle or driver operating a vehicle is speeding at a rate in excess of 10 miles over the posted speed limit with high frequency, a violation code can be applied to this event. In doing so, a behavior pattern allowing an interested party to identify potential violation patterns and determine associated risk levels.

Logic block 308 illustrates that database queries can be returned to users of the present invention. For example, driving performance reports can be generated (as detailed in FIG. 7). These reports can include formatted performance data for review by an inquiring party (e.g., an insurer or other party) in a standardized format. Information contained in the report can be utilized within the inquirer's internal processes as a data component (that will be utilized with many other internal and external data components) in a decision determination whether it be to set a price for insurance or to other identified business use.

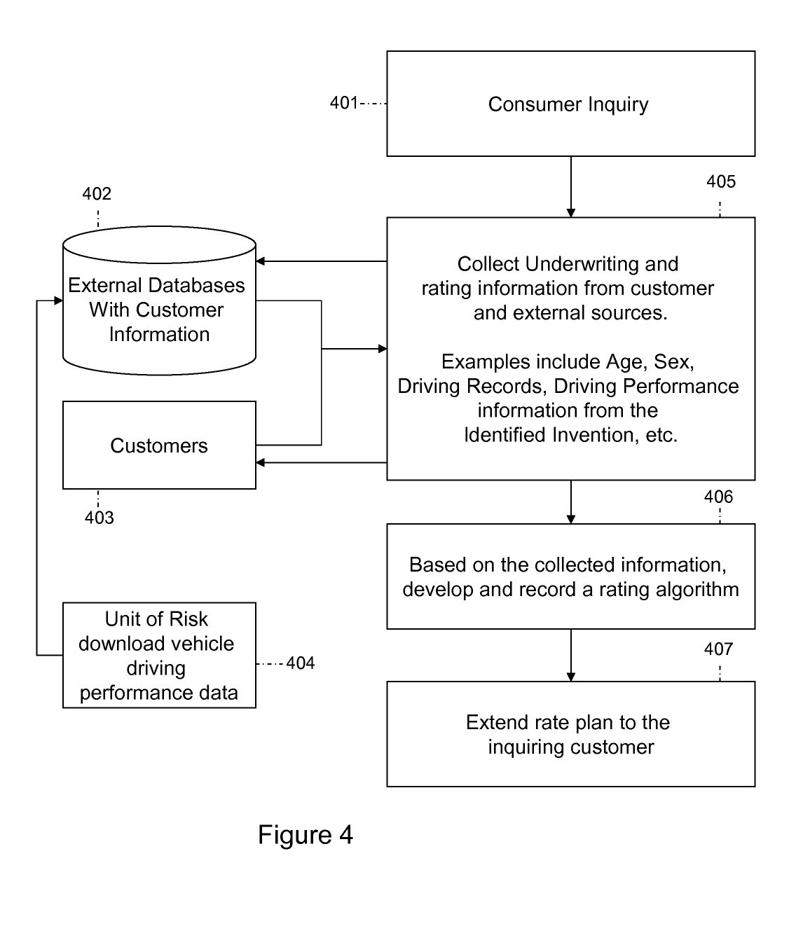

FIG. 4 illustrates a logical flow/block diagram 400 of an underwriting and rating method for determining a cost of insurance in accordance with some embodiments of the present invention. Other industry process may be very similar to this process diagram but would be specific to the industry or area of business services. It should be understood that FIG. 4 is but one exemplary use of embodiments of the present invention and that other uses outside of the insurance industry are contemplated.

The diagram 400 illustrates a potential use of the present invention in an insurance application setting. Logic block 401 illustrates a consumer making an inquiry to obtain insurance (or other product and/or service). Logic block 402 illustrates that one or more databases (e.g., a centralized contributory database) containing information regarding the inquiring customer are provided. The centralized contributory data repository will be one of these databases that will provide information on driving performance and potential risk associated with driving behavior. Additional information can be extracted from other database services and multiple service providers that include but are not limited to information related to age, gender, location or address, vehicle type, vehicle age, claims history, etc. Logic block 403 shows that the logical flow 400 can include obtaining information from consumers to process an application. Received information can include but is not limited to name, address, date of birth, drivers license number, social security number, phone number, vehicle registration information, current insurance policy information, etc. Logic block 404 illustrates that driver performance data (detailed in FIG. 7) can be housed in the centralized contributory data repository and collected as part of the data collection efforts outlined above.

The logical flow 400 also includes several data analysis decisions resulting in an answer regarding the provision of insurance. For example, logical block 405 shows various data being collected and logical block 406 shows that an insurer can analyze the collected date (as discussed herein) to arrive at a decision point and determine a rating plan based on the information made available from these multiple sources and internal rate determination matrices. And logical block 407 illustrates that an insurer reaches a decision to extend coverage at an identified rate plan to an inquiring customer.

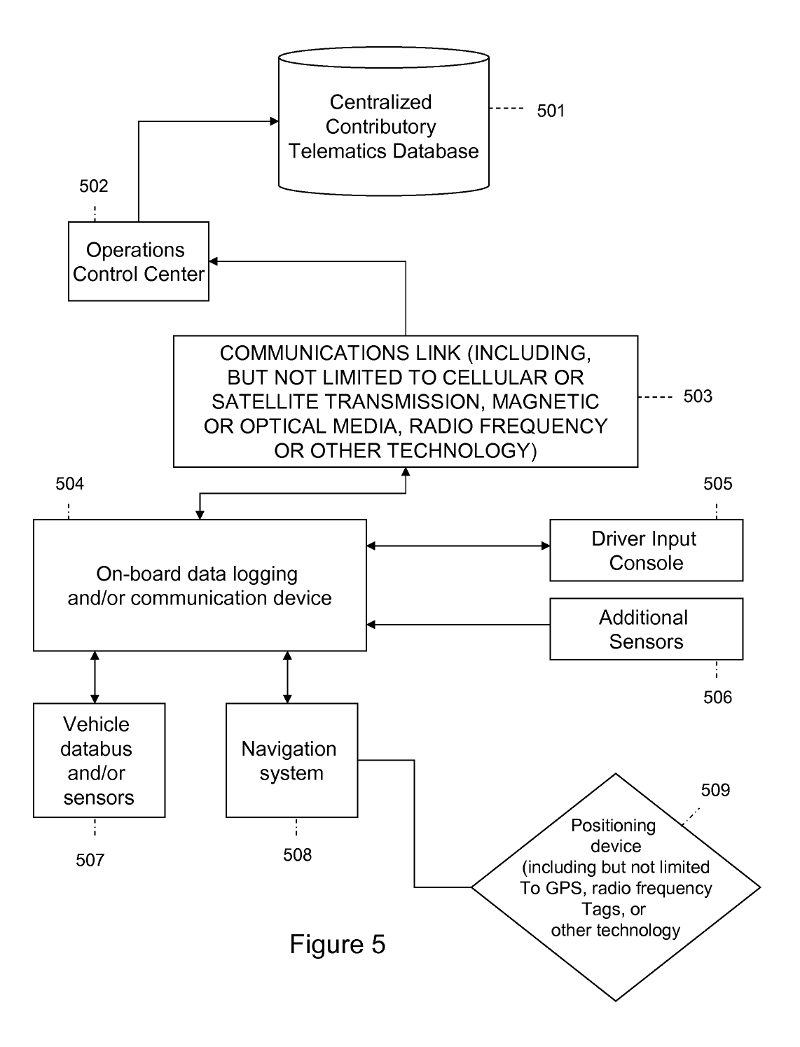

FIG. 5 illustrates a logical flow/block diagram 500 of a vehicle onboard computer and recording system capable of being used as part of embodiments of the present invention. According to some embodiments, the present invention can be implemented for communication with a central operations control center and a global positioning navigation system. Telematic data can be submitted as part of their data contribution into a shared repository. Vehicle telematic devices may be comprised of several principal components, such as an on-board data storage device, an input/output subsystem for communicating to a variety of external devices, a central processing unit and memory device and a real time operating kernel for controlling the various processing steps of the device. Telematics devices essentially communicate with one or more machine or vehicle components for acquisition of information representative of various actual vehicle operating aspects or characteristics.

In some embodiments, driver controls can be provided. For example, a driver input console may allow the driver to input data for satisfaction of various threshold factors which need to be satisfied. The console may allow the machine operator to enter an identification number so that operational characteristics can be recorded in association with a particular machine operator. Alternatively, the console may include a biometric sensor, such as, for example, a finger print or retinal scanner for positively identifying the operator. The physical operation of the vehicle is monitored through various sensors in operative connection with the vehicle or machine data bus, while additional sensors not normally connected to the data bus can be in direct communication with the telematic monitoring/recording device.

Vehicles can be configured to communicate with wireless networks according to embodiments of the present invention. For example, a vehicle can be linked to an operation control center by a communications link preferably comprising a conventional cellular telephone interconnection, but also comprising satellite transmission, magnetic or optical media, radio frequency or other known communication technology. A navigation sub-system may receive radio navigation signals from a positioning device which may include, but is not limited to GPS, radio frequency tags, or other known locating technology. If these elements are included, they may communicate with the device directly or via the data bus. Monitored information is recorded and uploaded to the telematics service provider for specific business use within the normal means of their operation. This information is then contributed to the centralized contributory data repository.

Now turning to FIG. 5, which shows a logical illustration of the above discussed material, there is shown a centralized contributory data repository 501 available for inquiry processing. FIG. 5 also shows an operation control center 502. A vehicle and its telematic devices can be linked by a communications link, such as communications link 503. The telematic devices can record diving performance data communicated from the vehicle for extended periods and this material can be stored into the data repository 501. Communications link 503 can comprise a cellular telephone interconnection, satellite transmission networks, and also magnetic or optical media, radio frequency, and many other communication technologies.

FIG. 5 also illustrates exemplary vehicle components used in the FIG. 5 embodiment of the present invention. For example, an on-board data logging or communications device 504 is show. This device 504 can be configured to record desired information associated vehicle performance and operation. Also shown, is a driver input console 505. This console 505 may allow the driver to input data for satisfaction of various threshold factors which need to be satisfied. For instance, the console may allow the machine operator to enter an identification number so that operational characteristics can be recorded in association with a particular machine operator.

FIG. 5 also shows other features capable of being implemented with the various embodiments of the present invention. For example, additional sensors 506 that are not normally connected to the data bus can be in direct communication with the telematic monitoring/recording device. Also shown is a vehicle or machine data bus 507 through which the physical operation of the vehicle is monitored through connection to the various sensors in operation. In some embodiments, a navigation system 508 may receive radio navigation signals from a positioning device; the navigation system 508 can also be used to record and transmit telematic data as desired. To do so, the system 508 can include a navigation sub-system which can comprise a GPS, radio frequency tags, or other known locating technology.

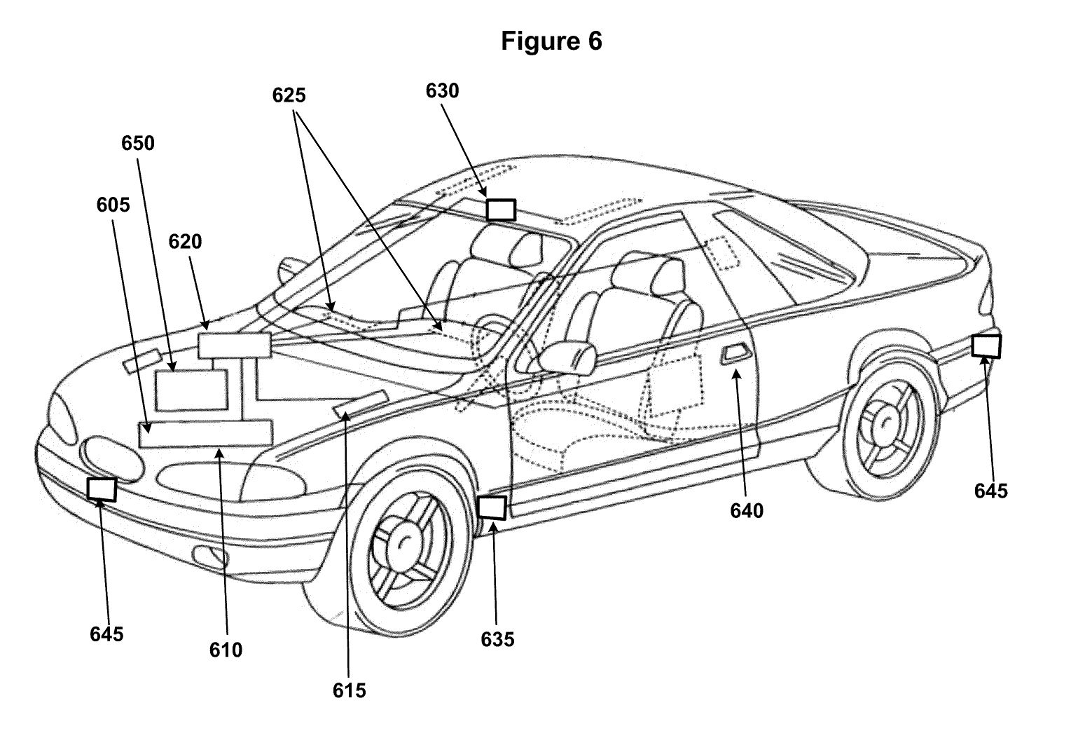

FIG. 6 illustrates a perspective view of a vehicle 600 equipped with various sensors to provide data and capable of being used as part of embodiments of the present invention. The exemplary motor vehicle 600 is shown in which the necessary apparatus (current OEM device or aftermarket addition) for use by the subject invention is included. An on-board device monitors and records various sensors and operator actions to acquire the desired data for determining accurate driving performance levels and associated risk scores. The various sensors associated with the motor vehicle to monitor a wide variety of raw data elements. Such data elements are communicated to such telematic devices through a connections cable which is operatively connected to a vehicle data bus through physical connector, such as, for example, an industry standard connector known as an SAE-1962 or On Board Diagnostic connector (e.g., ODBI, ODBII or in the near future ODBIII).

Additionally, communications connections such as these may be made wirelessly, such as, for example, with the wireless technology currently known as Bluetooth®. A driver input device may also be operatively connected to the telematic device through connector and cable. The telematic device is powered through the car battery, a conventional generator system, a device battery or a solar based system (not shown).

A device specific power source or battery may be included in the device even where main device power is drawn from the machine (motor vehicle). For instance, a device battery may provide power for a device clock, device memory and/or allow the device to record connection and disconnection events. Tracking of the vehicle for location identification can be implemented by the device through navigation signals obtained from a GPS (global positioning system) antenna, a differential GPS or other locating system. The communications link to a central control station may be accomplished through the cellular telephone, radio, satellite or other wireless communication system. However, the wireless communications system is not required.

Various sensors that can be used with the vehicle 600 include the following: horn 605, battery 610, brake system 615, electronic control units 620, SRS airbag systems 625, navigation systems 630, telematics control unit 635, door locks 640, front and rear electronic control units 645, and vehicle operational status sensors 650. It should be understood that additional sensors may also be employed to provide telematic data.

FIG. 7 illustrates a display screen/driving performance report 700 detailing customer response of information capable of being derived from a centralized repository in accordance with some embodiments of the present invention. The various data fields shown on the sample report include the following (it should be understood that various other data fields can also be shown on various other reports):
Data Field 701 references that a recorded pattern has been identified.
Data Field 702 references a monitoring start date for a specific drive or vehicle.
Data Field 703 references a monitoring end date for a specific vehicle or driver.
Data Field 704 references application of standard violation codes (SVC) to identified behavior patterns that exist within the driving performance data.
Data Field 705 references text description of SVCs applied to specific behaviors identified within the driving performance data.
Data Field 706 references an exception time recorded in an SVC reportable pattern or activity. An example of this would be the determination that a vehicle or driver operating a vehicle is speeding at a rate in excess of 11-20 miles over the posted speed limit for the recorded 96 minutes and 25 seconds.
Data Field 707 references an exception percentage (%) that is defined as the amount of time a vehicle is operated in a SVC reportable manner in comparison to the total time in operation.
Data Field 708 references a vehicle identification number standardized to a 17 digit number assigned by the manufacturer that is used to identify a specific vehicle.
Data Field 709 references a driver identification number that can be the number provided to a driver on their state issues drivers license or may be a driver biometric number assigned by the inventor that is derived from specific driving patters and behaviors.
Data Field 710 references driver performance risk score that is developed utilizing data attributes associated with the data related to the driver or vehicle in question (both driver performance data from the centralized contributory data repository as well as data from a proprietary claims history database). This risk score can correlate the propensity for potential loss associated with specific driving performance behaviors. Like a credit score, the higher the score, the better your risk score will be which translates into the less likely you are to have claims loss currently and in the future.

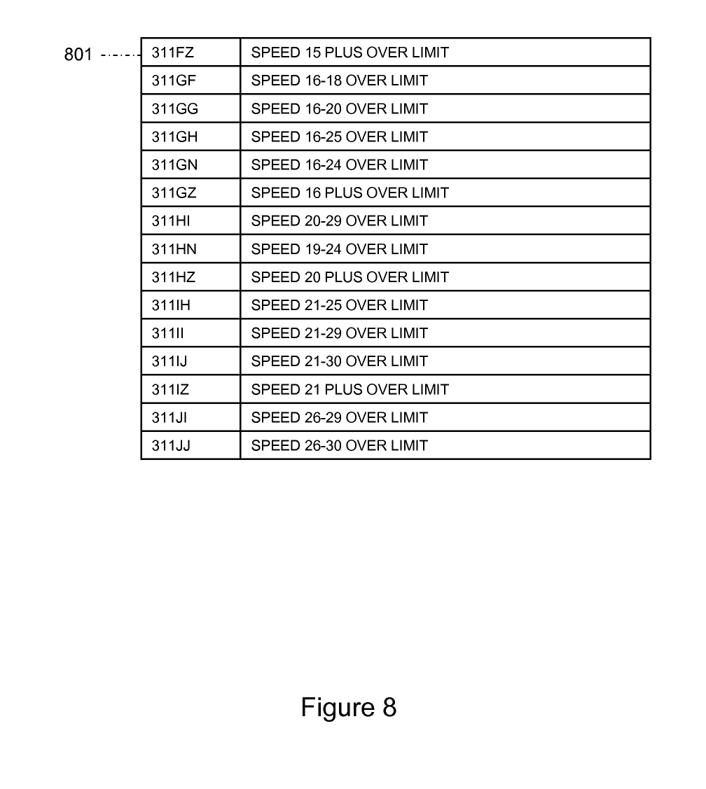

FIG. 8 is an example listing of violation codes that can be utilized to standardize violation activity into uniform classifications in accordance with some embodiments of the present invention. Shown in FIG. 8 is a snapshot example of several sample codes used to standardize violation activity. The 15 codes displayed in this example all relate to speeding violations while operating a vehicle.

The essence of the present invention is to provide a centralized repository of telematic based vehicle and driver performance data derived from multiple sources and vendors and aggregated through proprietary processes resulting in a consolidated view of driving attributes for a specific individual or specific vehicle.

Additionally, this centralized repository would provide numerous cost saving and time saving benefits to consumers who would be able to easily have their vehicle or driving performance information or profile available to insurers they wish to obtain new policy quote from providing the insurer with the ability to accurately quote and possibly bind coverage if rates are agreeable.

Similar to credit bureaus and the benefits they bring consumers when requesting the extension of credit when making purchases, consumers will not have to deal with the inconvenience of data accumulation in order to help justify a policy rate. They will avoid having to take their vehicle to multiple insurance field office locations for telematic readings. Also, an available history of safe driving and vehicle operation practices over an extended period of time will help to reduce initial rates as insurers will be able to justify their premiums based on extended driving performance rather than a short term period (usually less than 30 days) where a potential new policyholder's driving attributes are monitored to develop a rate.

Telematic based vehicle and driver performance data is derived from on-board devices that monitor and record various vehicle imbedded sensors and operator actions to acquire the desired data for determining an accurate view of how the vehicle is driven and how the driver performs. Multiple operating sensors are associated with the motor vehicle to monitor a wide variety of raw data elements. Such data elements are communicated to a standard event recorder also known as a “black box” through a connection cable which is operatively connected to a vehicle data bus through physical connector. Additionally, communications connections such as these may be made wirelessly.

Tracking of the vehicle for location identification can be implemented through navigation signals obtained from a GPS (global positioning system) antenna, a differential GPS or other locating system. The communications link to a central control station may be accomplished through the cellular telephone, radio, satellite or other wireless communication system.

The physical operation of the vehicle is monitored through various sensors in operative connection with the vehicle or machine data bus, while additional sensors not normally connected to the data bus can be in direct communication with the device.

The vehicle may be linked to an operation control center by a communications link, preferably comprising a conventional cellular telephone interconnection, but also comprising satellite transmission, magnetic or optical media, radio frequency or other known communication technology. A navigation sub-system may receive radio navigation signals from a positioning device which may include, but is not limited to GPS, radio frequency tags, or other known locating technology. If these elements are included, they may communicate with the device directly or via the data bus.

The data would be contributed by VIN number or LN derived data ID to allow for linking the various data elements to a specific individual or vehicle and would be submitted and received on a recurring basis (including, but not limited to, daily, weekly, monthly, semi-annually or annually). Data will be subject to multiple data validation and load routines to ensure data quality and consistency of search routines and response output. Examples of data that can be recorded and monitored to determine driving performance and the risk associated with it include, but are not be limited to:
Actual miles driven;
Types of roads driven on (high risk vs. low risk); and,
Safe operation of the vehicle by the vehicle user through:
   speeds driven,
   safety equipment used, such as seat belt and turn signals,
   time of day driven (high congestion vs. low congestion),
   rate of acceleration,
   rate of braking (deceleration),
   observation of traffic signs.
Driver identification

Specific data elements may be contributed to aid in the development of driver performance records that may include raw data elements, calculated data elements, and derived data elements. For example, these can be broken down as follows:

### Raw Data Elements:

Information from power train sensors
   RPM
   Transmission setting (Park, Drive, Gear, Neutral)
   Throttle position
   Engine coolant temperature
   Intake air temperature
   Barometric pressure
Information from electrical sensors
   Brake light on
   Turn signal indicator
   Headlamps on
   Hazard lights on
   Back-up lights on
   Parking lights on
   Wipers on
   Doors locked
   Key in ignition
   Key in door lock
   Horn applied
Information from body sensors
   Airbag deployment
   ABS application
   Level of fuel in tank
   Brakes applied
   Radio station tuned in
   seat belt on
   Door open
   Tail gate open
   Odometer reading
   Cruise control engaged
   Anti-theft disable
   Occupant in seat
   Occupant weight
Information from other elements
   Vehicle speed
   Vehicle location
   Date
   Time
   Vehicle direction
   IVHS data sources
   Pitch and roll
   Relative distance to other objects.

### Calculated Information:

Deceleration
Acceleration
Vehicle in skid
Wheels in spin
Closing speed on vehicle in front
Closing speed of vehicle in rear
Closing Speed to vehicle to side (left or right)
Space to side of vehicle occupied
Space to rear of vehicle occupied
Space to front of vehicle occupied
Lateral acceleration
Sudden rotation of vehicle
Sudden loss of tire pressure
Distance traveled
Environmental hazard (example: Rain conditions)

### Derived Data Elements:

Vehicle speed in excess of speed limit
Observation of traffic signals and signs
Road conditions
Traffic conditions
Vehicle position

The recording and thus contribution of data to reside in our solution repository may include monitoring a plurality of raw data elements, calculated data elements and derived data elements as identified above. Each of these is representative of an operating state of the vehicle or an action of the operator and therefore, represents an operational aspect of the machine. Select ones of the plurality of data elements are recorded when the ones are determined or believed to have an identified relationship to the overall driving performance risk standards. For example, vehicle speed is likely to be related to driver or vehicle driving performance. Therefore, speed may be recorded on a regular basis.

Alternatively, where memory or storage space is a factor, speed may be recorded less often when it is below a threshold. The recording may be made in combination with date, time and/or location information. Other examples of data that may be recorded are excessive rates of acceleration or hard braking (deceleration) events. These may be calculated data elements determined, for example, from speed measurements made every second or can be measured data elements received directly or indirectly from one or more accelerometer of the vehicle. The recording process is practically implemented by monitoring and storing the data in a buffer for a selected period of time. Periodically the status of all monitored sensors for the data elements is written to a file which is stored in the vehicle data storage component. The raw, calculated and derived data elements listed above comprise some of the data elements to be so stored and then contributed.

An added benefit to the solution that includes a central repository is the development of proprietary data attributes. These attributes will represent standardized measurements across many of the database inputs and may be used to develop industry or custom predictive scores as well as develop driver, driving and vehicle profiles, indicators, flags or triggers.

These attributes may be used independently or combined with other data for analysis, appending, monitoring or storing for current and future usages. These attributes may be customized for individual uses to best fit each need, and may be combined in a number of ways with other data elements. The number, definition and usage of these attributes will continue to change over time.

Driver performance risk score calculates a relative numeric score reflecting the risk posed by the vehicle operator in relation to potential claims loss. Driver score incorporates basic vehicle exception data (including but not limited to speed, acceleration/deceleration, braking) as well as information reflecting prior traffic offenses, insurance claims, financial data (BLJ, credit), loss history data and other sources of driver data to establish scoring relativities. Additional sources of data including police/criminal records, court data, and civil filings may be incorporated along with other public and proprietary data sets in the future.

The calculated driver performance report is comprised of the numeric driver performance risk score along with the number of occurrences in a variable time period (determined by the inquirer) where an exception occurrence was recorded along with an industry Standard Violation Code (SVCSM) to help describe the occurrence. The report will also include a measurement of the percentage of time an exception occurrence was recorded for the total operation time of the vehicle. The driver performance report will also utilize a predictive component to reflect a drivers propensities indicated by the SVCs, which include, but are not limited to:
Speed Infractions
Disregarding Traffic Control Devices
Unsafe Vehicle Operation
Accidents

A calculated driver score would be a numeric value that falls within a predetermined range, and be supplemented by a most-to-least likely ranking of violations (utilizing SVCs) most likely to be committed by the driver based on prior driving experience.

Operating score reflects the risk associated with the hours of operation (peak vs. non-peak), number of miles driven, location of operation (if permitted by law), and general driver behavior including the operating characteristics noted in the data elements listing above. Operating score and a consolidated standard vehicle operation profile would be assigned to an automobile where a unique driver cannot be identified or assigned or there are a number of operators all of whom use the vehicle (e.g. a large fleet, etc.).

Vehicle risk reflects the risk posed by vehicle maintenance sensor status to determine the maintenance level on the insured auto. A score may be developed that reflects the attention to regularly scheduled maintenance on the part of the owner. In addition, vehicle risk will be correlated with a proprietary database of historical loss payment information to reflect an average payment for physical damage claims associated with the vehicle. The damage and risk assessment may be more closely tailored to a unique operating area.

An aggregated driver profile will be correlated with driver performance information, vehicle profiles and loss data (by type of coverage and policy limits) to provide an overall risk score. Driver score, operating score, and vehicle risk are useful tools to assist Insurance underwriters, employers, and government agencies make informed decisions on the insurability and/or risk presented by a particular vehicle or driver. Applying the scores will help insurance carriers better price and rate insurance risks.

Data is collected regularly at pre-determined intervals (including, but not limited to, single one-time submissions along with daily, weekly, monthly, quarterly, semi-annual, or annual submissions) when the vehicle is being operated, and at the end of every calendar month the accumulated data is scored to create the risk profiles. The profile is kept on-line and used for comparison with subsequent calculations to evaluate changes in the risk and requisite premium associated with the risk.

Data that has been collected, aggregated, and loaded into a central repository for use in producing the risk profiles that is no longer needed for this purpose will subsequently be stored off-line, in a non-production environment. The data will need to be retained for audit and legal purposes for a period to be determined.

The current/existing insurance carrier for the risk and prospective carriers to which the driver has applied for a policy of automobile insurance have the ability to query the database to retrieve the data. For insurance carriers, employers and government agencies able to receive data ‘pushed’ to them, a file is transferred regularly (for example, monthly, semi-annually, annually) for their use in monitoring the vehicle and/or the driver. The information may be used to re-underwrite or rate an insurance policy or for shipping/transportation logistics, public safety analysis/design efforts, and employee monitoring.

If the consumer seeks other insurance, a new prospective insurance carrier can query the database and retrieve a history for the vehicle and driver that provides insights into specific driving performance and propensity for future loss for a prior period, for example the prior 12-36 months.

The embodiments of the present invention are not limited to the particular formulations, process steps, and materials disclosed herein as such formulations, process steps, and materials may vary somewhat. Moreover, the terminology employed herein is used for the purpose of describing exemplary embodiments only and the terminology is not intended to be limiting since the scope of the various embodiments of the present invention will be limited only by the appended claims and equivalents thereof.

Therefore, while embodiments of the invention are described with reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all equivalents.

We claim:

1. A system to provide driving performance data, the system comprising:
a centralized database configured to receive and store telematic driver data and vehicle data from a plurality of unique data sources, the data concerning a plurality of drivers and automobiles;
a driving performance engine configured to analyze data stored in the centralized database and in response to the analysis to provide a driver performance risk score that indicates a level of insurance risk associated with at least one of a driver or a vehicle.

2. The system of claim 1, further comprising a data receipt processor operable to manage receipt of telemetric driver and vehicle data in a first data format and transform at least some data elements of the telemetric driver and vehicle data into a second data format.

3. The system of claim 1, wherein the driving performance engine generates a driving performance report in response to an inquiry requesting a driving performance report, wherein the driving performance report includes the driving performance risk score and on or more data elements comprising driving performance dates, monitoring periods, vehicle/driver risk situations, and a vehicle identification number.

4. The system of claim 1, further comprising a stand violation code engine configured to assign one or more violation codes to events in a driver historical record and evaluate the assigned codes to determine violation patterns and driving risk levels.

5. The system of claim 1, wherein the driving performance engine provides the driver performance risk score as a function of driver performance data and driver insurance claims history.

6. The system of claim 1, wherein the driving performance engine provides the driver performance risk score as a function of vehicle performance data and vehicle insurance claims history.

7. The system of claim 1 further comprising a plurality of data interfaces configured to receive telemetric driver and automobile data from a plurality of unique users in a plurality of unique data formats.

8. The system of claim 1, wherein the driving performance engine provides the driver performance risk score for a specific driver based on a correlation of a propensity of claims loss factor relative to the specific driver's driving performance data.

9. The system of claim 1, wherein the driving performance engine provides the driver performance risk score at a predetermined frequency so that the frequently provided driver performance risk score can be used to adjust an insurance rate associated with a driver or a vehicle.

10. The system of claim 1, wherein the vehicle data includes vehicle operational characteristics.

11. A method of obtaining driving performance data to provide one or more driving performance risk scores derived from received data, the method comprising:
receiving an initial data set into a memory, the initial data set comprising telematic data that includes driving performance data;
transforming at least a part of the initial data set into a production data set such that the transformation augments certain data elements in the initial data set into predetermined states;
storing the production data set into a centralized data repository;
receiving one or more data inquiries from one or more interested parties and in response to the one or more data inquiries providing a driving performance risk score based on data stored in the centralized data repository, wherein the driving performance risk score indicates a level of insurance risk.

12. The method of claim 11, wherein transforming the initial data set into a production data set comprises formatting and validating the initial data set, and changing elements in the initial data set based on the formatting and validating.

13. The method of claim 11, wherein the driving performance risk score is provided for at least one of a unique driver or a unique automobile.

14. The method of claim 11, wherein providing the driving performance risk score comprises correlating driver performance data with historical insurance claim information for a unique driver.

15. The method of claim 11, wherein providing the driving performance risk score includes applying a set of predetermined violation codes to the production data set to enable pattern

16. The method of claim 11, further comprises generating a performance driving report that includes the driving performance risk score and on or more data elements comprising driving performance dates, monitoring periods, vehicle/driver risk situations, and a vehicle identification number.

17. The method of claim 11, wherein receiving an initial data set comprises receiving data from one or more of a consumer, a telematics service provider, or an insurer.

18. The method of claim 11, wherein receiving an initial data set comprises receiving data collected by telematic sensors positioned to collect driving data in or more vehicles.

19. The method of claim 11, wherein receiving an initial data set comprises receiving data from a plurality of unique insurers in varying data formats.

20. The method of claim 11, wherein providing the driving performance risk score occurs at a predetermined frequency so that the driving performance risk score can be used by an end user.

21. The method of claim 20, wherein the end user use includes using the driving performance risk score as a component in providing an insurance rate associated with a driver or a vehicle.

22. The method of claim 11, wherein an insurance decision engine uses the driving performance risk score to determine change to an existing insurance policy, to review an insurance policy, or alter a rate of an existing policy.
